(19) United States
(12) Patent Application Publication
(10) Pub. No.: US 2006/0230893 A1
(43) Pub. Date: Oct. 19, 2006

(54) METHOD AND APPARATUS FOR PRODUCING MULCH

(76) Inventor: Charles Allen Brooks, Graham, NC (US)

Correspondence Address: ADAMS EVANS P.A., 301 SOUTH TRYON STREET, SUITE 2180, TWO WACHOVIA CENTER, CHARLOTTE, NC, 28282-1991, US

(21) Appl. No.: 11/379,124

(22) Filed: Apr. 18, 2006

Related U.S. Application Data
(60) Provisional application No. 60/672,271, filed on Apr. 18, 2005.

(51) Int. Cl. B26D 1/00; B26D 1/46

(52) U.S. Cl. 83/13; 83/801; 83/835

(57) ABSTRACT

A method and apparatus for producing mulch. The apparatus includes a saw blade assembly having a cutter defining a cutting plane, and a clamp assembly for holding a log. The clamp assembly holds the log with its grain substantially parallel to the cutting edge. The apparatus further includes a movement means for repetitively moving the clamp assembly and saw blade assembly relative to each other so as to feed the saw blade assembly into the log while the grain remains substantially parallel to the cutting plane, so that the saw blade assembly removes thin, narrow strips of wood mulch from the log.

### TECHNICAL FIELD AND BACKGROUND OF THE INVENTION

This application claims the benefit of Provisional Application No. 60/672,271 filed on Apr. 18, 2005.

This invention relates to a method and apparatus for producing mulch, particularly mulch of the type that can serve as a suitable substitute for pine needle mulch. Pine needles, sometimes referred to as “pine straw”, are a common bedding plant mulch and ground cover, particularly in the southeastern United States, where pine trees are found in large numbers. Mulch provides an attractive cover for planting areas, retains moisture in the soil, insulates the soil and plants in cold or hot weather, and over time as it decays, incorporates additional organic matter into the soil.

Pine needles are generally harvested and baled for sale by manually raking the needles off of the ground, or by using various rake-type machines that sweep the needles off of the ground, compress the needles into bales, and bind the bales with twine for shipment. Pine needles are popular as a mulch because the product has historically been relatively inexpensive and widely available. When properly harvested, the product is clean and, at least initially, has a pleasant, aromatic scent.

However, pine needles are not as plentiful as in the past because of harvesting of pine forests for use as paper pulp and wood construction products, and to make land available for development. Pine needles are relatively straight and thus tend to pack down after a relatively short period of time. Maintaining the proper appearance of the planting bed therefore requires periodic fluffing of the material, or supplementing the bed with additional pine needle material as it compacts. In addition, harvesting pine needles also frequently results in sticks, limbs, pine cones and other unwanted material being incorporated into the bales, thus lessening the quality of the product and often requiring removal when the needles are being unbaled and applied to planting beds.

For these reasons, a need exists for a mulch product that can be produced in large quantities at low cost, from readily available and variable raw materials, and that will serve as an effective substitute for pine needle mulch. The present invention provides an effective method of producing large quantities of mulch having many of the characteristics of pine needle mulch without the disadvantages, and a mulch product that meets requirements for planting bed and ground cover mulch.

### SUMMARY OF THE INVENTION

Therefore, it is an object of the invention to provide a method of producing an organic mulch product.

It is another object of the invention to provide a mulch product that is an effective substitute for pine needle mulch.

It is another object of the invention to provide a mulch product that can be processed in large quantities and utilized in the same manner as pine needle mulch.

These and other objects of the present invention are achieved in the preferred embodiments disclosed below by providing an apparatus for producing mulch. The apparatus includes an elongate saw blade assembly having a cutter defining a cutting plane and a clamp assembly for holding a log. The clamp assembly holds the log with its grain substantially parallel to the cutting edge. The apparatus further includes a movement means for repetitively moving the clamp assembly and the saw blade assembly relative to each other so as to feed the saw blade assembly into the log while the grain remains substantially parallel to the cutting plane, so that the saw blade assembly removes thin, narrow strips of wood mulch from the log.

According to another preferred embodiment of the invention, the clamp assembly is mounted for both horizontal and vertical movement.

According to another preferred embodiment of the invention, the clamp assembly is mounted for horizontal movement and the saw blade assembly is horizontally disposed to cut an outermost side of the log.

According to another preferred embodiment of the invention, the saw blade assembly includes at least two saw blades each having a cutter positioned in a vertically-staggered orientation such that each of the saw blades cuts an outermost side of the log.

According to another preferred embodiment of the invention, the clamp assembly includes a pair of clamps for engaging opposing ends of the log and securing the log therebetween, at least one of the clamps being mounted for movement between an open position for receiving the log and a closed position for securing the log.

According to another preferred embodiment of the invention, the saw blade assembly includes at least two saw blades each having a cutter stacked in registration with each other.

According to another preferred embodiment of the invention, an apparatus for producing mulch includes an elongate saw blade assembly having a cutter defining a cutting plane; a clamp assembly for holding a log with its grain substantially parallel to the cutting plane; and a reciprocating means for moving the clamp assembly and the saw blade assembly in a reciprocating motion relative to each other so as to feed the saw blade assembly into the outermost side of the log repetitively while the grain remains substantially parallel to the cutting plane. The saw blade assembly removes thin, narrow strips of wood mulch from the log.

According to another preferred embodiment of the invention, the clamp assembly is mounted for both horizontal and vertical movement relative to the saw blade assembly.

According to another preferred embodiment of the invention, the reciprocating means includes vertical and horizontal rails to allow the clamp assembly to move in the vertical and horizontal directions.

According to another preferred embodiment of the invention, the clamp assembly includes a table and a pair of clamps carried by the table.

According to another preferred embodiment of the invention, at least one of the clamps is moveable on the table between an open position for receiving the log and a closed position for holding the log.

According to another preferred embodiment of the invention, the saw blade assembly includes a plurality of blades stacked in registration with each other, each of the blades include a chain saw guide bar and a cutter carried by the guide bar.

According to another preferred embodiment of the invention, further including an automatic chain tensioner for adjusting the tension of the chain on the guide bar.

According to another preferred embodiment of the invention, further including spacers between the guide bars to prevent interference between the cutters of adjacent blades.

According to another preferred embodiment of the invention, a method of making mulch includes the steps of providing a mulch-producing apparatus having a saw blade assembly having a cutter defining a cutting plane and a clamp assembly, securing a log in the clamp assembly, and moving repetitively the saw blade assembly and log relative to each other such that an outermost side of the log is moved into engagement with the saw blade assembly. The method further including the step of cutting along the grain of the log with the saw blade assembly to produce thin, narrow strips of wood mulch.

According to another preferred embodiment of the invention, the saw blade assembly includes a plurality of saw blades each having each having a cutter.

According to another preferred embodiment of the invention, further including the step of moving the clamp assembly in a horizontal direction to position the outermost side of the log above the saw blade assembly.

According to another preferred embodiment of the invention, further including the step of moving the clamp assembly in a vertical direction to position the outermost side of the log into engagement with the saw blade assembly.

According to another preferred embodiment of the invention, further including the steps of moving the clamp assembly in a vertical direction to position the log above the saw blade assembly; moving the clamp assembly in a horizontal direction to position the outermost side of the log above the saw blade assembly by a thickness of the saw blade assembly; and moving the clamp assembly in a vertical direction to position the outermost side of the log into engagement with the saw blade assembly.

According to another preferred embodiment of the invention, the clamp assembly includes a pair of clamps carried by a table, at least one of the clamps being moveable between an open position for receiving the log and a closed position for securing the log.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a side elevation of a mulch-producing apparatus according to one embodiment of the invention;

FIGS. 2-5 are fragmentary sequential side elevation views of the mulch-producing apparatus;

FIG. 6 is a fragmentary top plan view of the mulch-producing apparatus; and

FIG. 7 is a fragmentary perspective view of the mulch-producing apparatus.

### DESCRIPTION OF THE PREFERRED EMBODIMENT AND BEST MODE

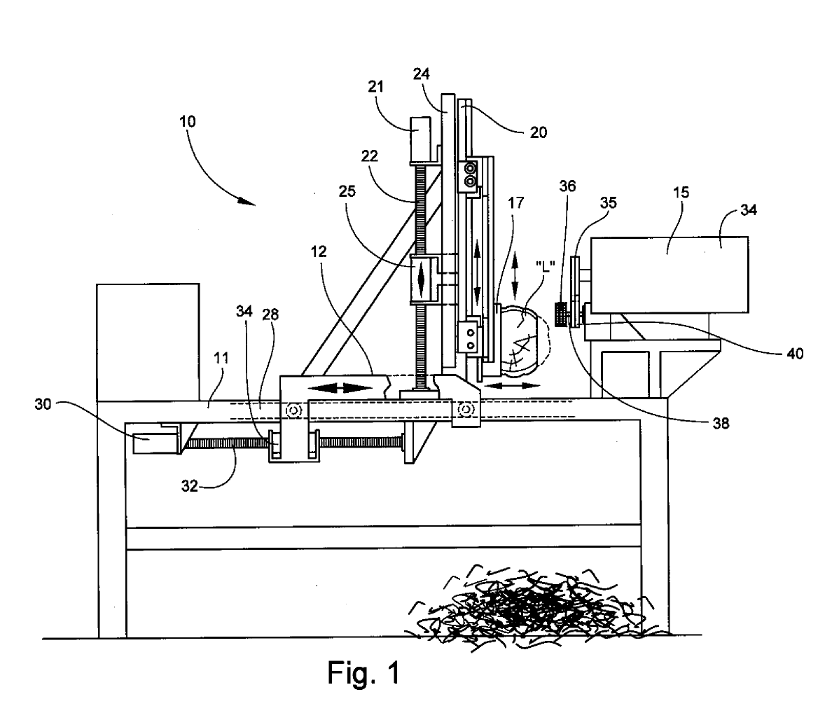

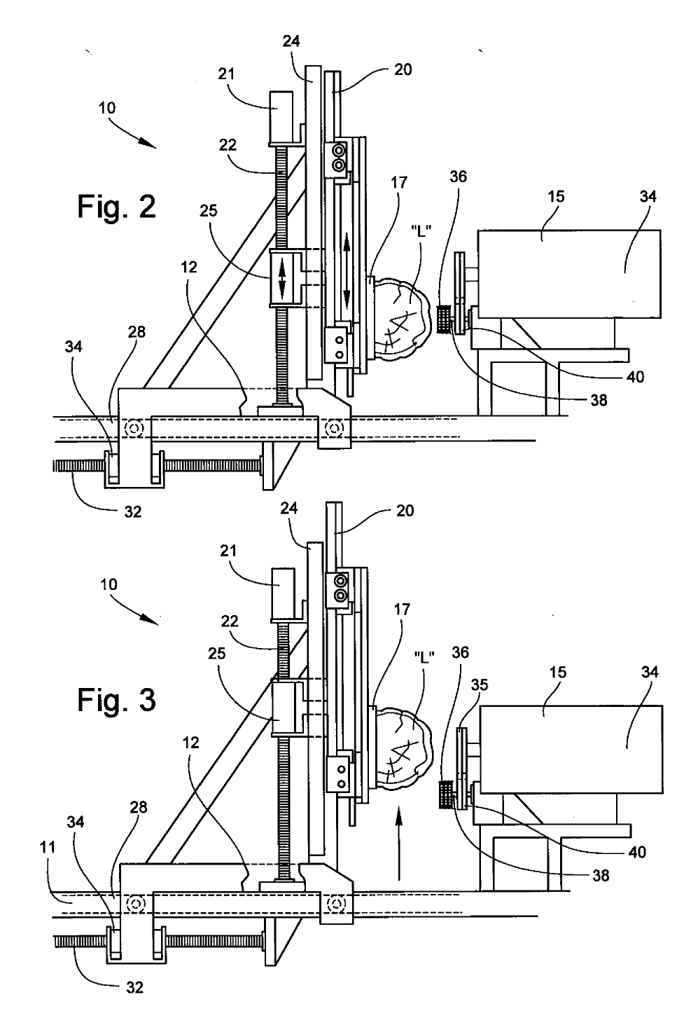

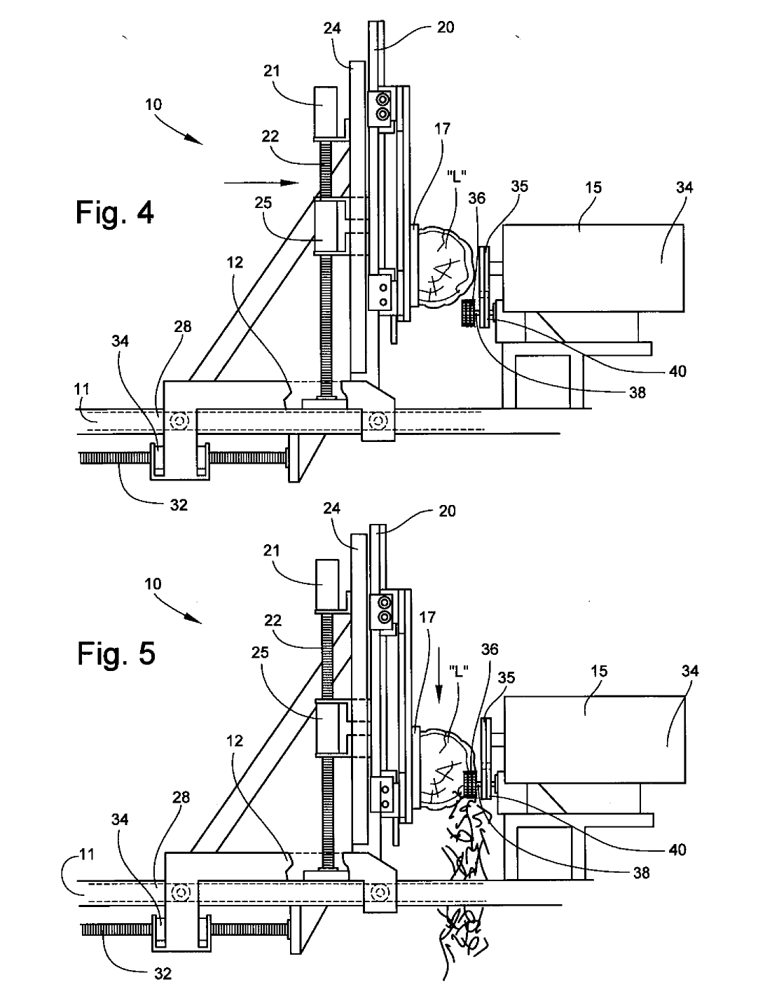

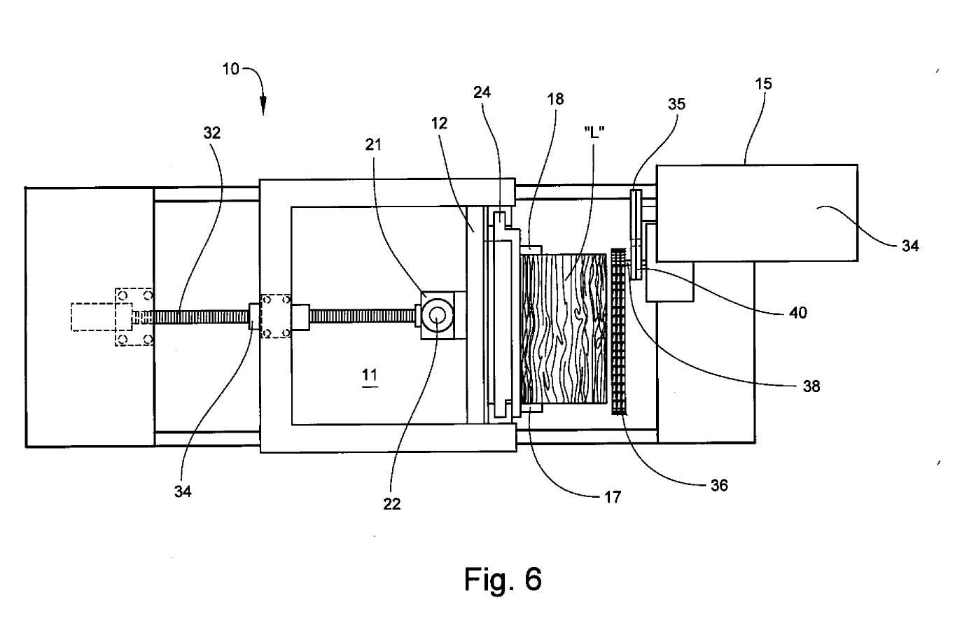

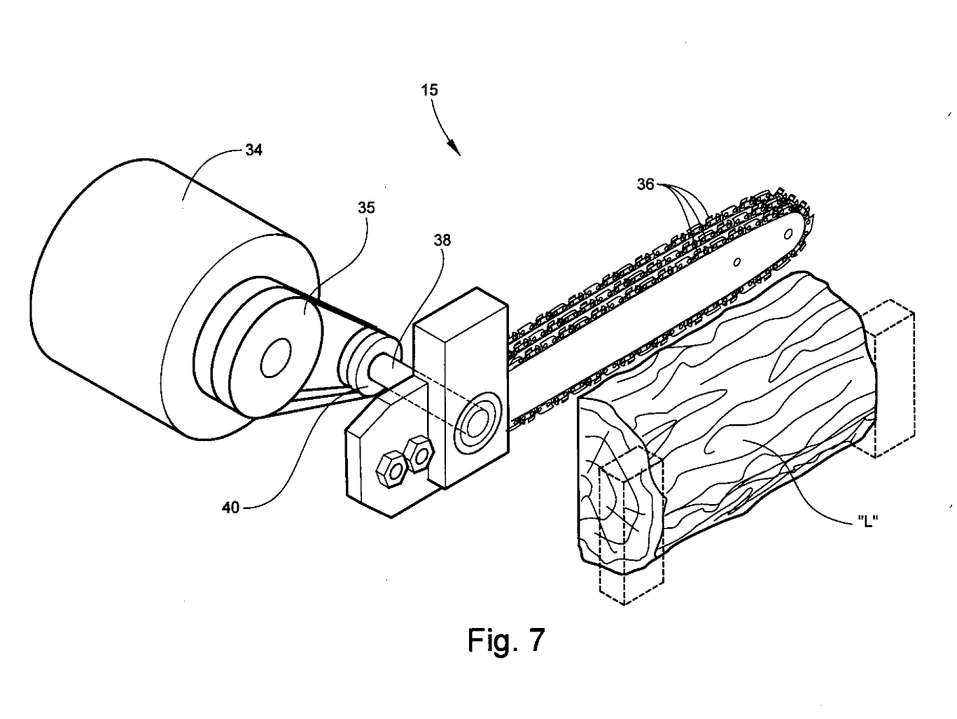

Referring now specifically to the drawings, a mulch-producing apparatus according to one embodiment of the invention is illustrated in FIGS. 1-6 and shown generally at reference numeral 10. The mulch-producing apparatus 10 includes a base 11 on which is positioned a feed table 12 mounted for both vertical and horizontal movement relative to a stationarily-mounted saw blade assembly 15. The table 12 includes a pair of clamps 17, 18 by which a log “L” is held in a fixed position relative to the table 12. One of the clamps 17, 18 is fixed in position on the table 12 and the other one of the clamps 17, 18 is mounted for movement between an open position for receiving the log “L”, and a closed position for clamping the log “L” into a stationary position. See FIGS. 6 and 7. The movable clamp is preferably hydraulically-controlled, but may be controlled by a pneumatic device, or with a mechanical clamp, such as an over-center latch.

The table 12 is mounted for vertical movement on a pair of vertical rails 20 and is moved in the vertical direction by a motor 21 driving a vertical worm gear 22 mounted on a table support frame 24 and extending through a vertical drive gear 25 carried by the back side of the table 12.

The table 12 is mounted for horizontal movement on a pair of horizontal rails 28 extending along the base 11, and is moved in the horizontal direction by motor 30 driving a horizontal worm gear 32 mounted on the base 11 and extending through a horizontal drive gear 34 carried by the back side of the table 12. The table 12 may also be moved manually by an individual in the vertical and horizontal directions.

The saw blade assembly 15 is mounted on the base 11 and includes a drive motor 34 for driving the saw blades 36 of the saw blade assembly 15. Preferably, the saw blade assembly 15 comprises a plurality of chain saw guide bars and chains horizontally stacked in registration with each other to collectively form an assembly capable of making a vertical cut of between 0.5 inch and 1 inch per pass; however, the assembly 15 may include only a single saw blade 36. The chain saw guide bars are mounted on a stationary mounting bar and include spacers between the guide bars to prevent interference between the chain teeth of adjacent blades. The overall depth of cut and the width of the individual shavings can be adjusted by altering the number and size of the guide bars and chains.

The drive motor 34 drives the chain saw chains through a pair of drive pulleys 35 and belts driving a drive shaft 38 extending through the drive end of the guide bars. An automatic chain tensioner (not shown) adjusts the tension of the chains on the guide bars after each pass to compensate for chain elongation resulting from heating of the chain during cutting.

In a preferred embodiment of the invention, three to six 20-41 inch stacked guide bars and chains are driven by a 5-HP, 2067 rpm motor with 6-inch drive pulleys 35 driving 2-inch driven pulleys 40 attached to a drive shaft 38 of the guide bars.

In operation, the log “L” is loaded into the clamps 17, 18 as described above with the table 12 in a raised and retracted position. Note that the longitudinal axis of the log “L” and thus the grain of the log extends along the length of the guide bars of the chain saw blades 36. The saw blade assembly 15 is turned on and the table 12 moves horizontally-inwardly until the outermost side of the log “L” is positioned at a position above the saw blades 36 by the thickness of the saw blades. The vertical worm gear 22 is activated and the vertical component of the table 12 is lowered in a continuous movement, bringing the outermost, overlapped part of the log “L” onto the saw blades 36. The saw blades 36 slice thin shavings of wood from the side of the log “L” and discharge them from the apparatus 10 in the cutting direction of the chain saw blades 36 into a pile for subsequent processing. Note that the shavings are formed in the grain direction of the log “L” as the log “L” is moved vertically against the saw blades 36, thus permitting the formation of long relatively thin strips with virtually no dust and with very few short lengths.

The spacers between the adjacent blades allow the individual blades to make separate, parallel and adjacent cuts across the width of the cut.

The chain tensioner is activated and applies proper tension to the chain. The table 12 is raised back to its starting position above the log 12, and then the horizontal worm gear 32 is activated and increments the table 12 inwardly by the amount of the cut, positioning the outermost edge of the remaining log “L” over the blades 36, as before. The table 12 is then lowered by activating the vertical worm gear 22, and the shavings are formed as described above. This process is repeated as many times as necessary to cut away the log “L” to a thickness only slightly greater than the depth of the clamps 17, 18, at which time the table 12 is retracted away from the blades 36, the movable clamp moved to the loading position and the remaining piece of log “L” removed. The remaining piece of log “L” is preferably split into suitable-sized pieces for use as firewood or kindling. A new log “L” is loaded into the apparatus 10 and the process is repeated.

In another embodiment of the invention, not shown, a mulch-producing apparatus comprises a horizontally-positioned table mounted for horizontal and vertical movement. A log is clamped to the underside of the table and the table is moved past a saw blade assembly having a plurality of chain saw blades mounted horizontally under the table, i.e., with both runs of the chain in the same horizontal plane. The plurality of blades are fixed in position and are mounted in a vertically-staggered orientation in relation to the position of the table. The first blade is positioned at a first position and makes a first cut. The second blade is mounted at a second position that is higher than the first blade by an amount equal to the thickness of the first cut and thus makes a second cut off of the lowermost side of the log. Third and subsequent blades may be provided and would operate in the same manner.

The table is reciprocated back to the starting position, the blades are retensioned, the table lowered to a position whereby the first blade is positioned relative to the log in order to make the first cut, and the process is repeated until the thickness of the log is reduced to the desired amount. A new log is mounted on the underside of the table and the process repeated. Preferably, each blade is mounted in an individual module that includes a motor, drive pulleys and mounting hardware. When necessary for repair or replacement, any module can be quickly detached and replaced with another module, thereby reducing downtime and lost productivity.

In another embodiment of the invention, not shown, a mulch-producing apparatus comprises saw blade assembly having at least one, angled blade that is stationarily mounted except for a slight back and forth motion. The wood is mounted to rotate at a high rate of speed. The blade and the wood are moved into contact with each other, and as the rotating wood is cut by the blade, the mulch is produced. The blades preferably remain fixed in depth position relative to the wood, and move back and forth to create the elongated shavings.

In yet another embodiment of the invention, not shown, a mulch-producing apparatus comprises a horizontally-positioned carousel mounted for rotation and for incremental vertical movement. Logs are clamped to the underside of the table at, for example, a 12 o'clock position and the table is rotated past a saw blade assembly having a plurality of chain saw blades mounted horizontally under the table from, for example, the 4 o'clock to 8 o'clock positions. The plurality of blades are fixed in position and are mounted in a vertically-staggered orientation in relation to the position of the table. The first blade is positioned at a first position and makes a first cut. The second blade is mounted at a second position that is higher than the first blade by an amount equal to the thickness of the first cut and thus makes a second cut off of the lowermost side of the log. Third and subsequent blades may be provided and would operate in the same manner. Preferably, a sufficient number of blades are provided so that the remaining portion of the log returns to the 12 o'clock position, is unloaded, a new log clamped into position and delivered to the blades, all in a continuous movement.

As described above, each blade may be mounted in an individual module that includes a motor, drive pulleys and mounting hardware.

While a wide variety of woods may be used, woods of varying sizes can be used, including cypress, cedar and poplar. Poplar is considered particularly desirable because it is inexpensive, readily available in quantity, grows straight, and thus has a straight grain. Several varieties of wood may be used interchangeably and mixed as desired.

The mulch shavings produced according to the above method are characterized by being very thin, narrow, long and slightly curly. The material bales easily and resists settling once applied, thus requiring less fluffing and supplementation. One embodiment of the mulch has an average length of about 6-14 inches, an average width of about 3/16 to ⅜ inch, and an average thickness of about 0.005 to 0.025 inch. A cubic foot of the material having the same density as ejected from the mulch-producing apparatus weighs approximately 0.40 to 0.75 pounds, depending on the residual moisture in the product.

The mulch may be further processed to enhance its usefulness and appearance. For example, the mulch may be colored with a natural earth pigmentation to darken it. The dyeing may be accomplished by introducing the shavings into a long, rotating tube, and spraying water in which the pigment is suspended onto the tumbling shavings as they transit the tube, exiting the other end. A starch inhibitor or other fungicide may optionally be applied to reduce fungus growth. The material may be dried with radiant or forced-air heat, sun-dried or baled in its damp condition, as required.

The material may be sold in bulk form, baled, bagged or otherwise treated as pine needles.

A mulch-producing apparatus is described above. Various details of the invention may be changed without departing from its scope. Furthermore, the foregoing description of the preferred embodiments of the invention and best mode for practicing the invention are provided for the purpose of illustration only and not for the purpose of limitation.

I claim:

1. An apparatus for producing mulch, comprising:
(a) an elongate saw blade assembly having a cutter defining a cutting plane;
(b) a clamp assembly for holding a log with its grain substantially parallel to the cutting plane; and
(c) movement means for repetitively moving the clamp assembly and the saw blade assembly relative to each other so as to feed the saw blade assembly into the log while the grain remains substantially parallel to the cutting plane;
(d) whereby the saw blade assembly removes thin, narrow strips of wood mulch from the log.

2. The apparatus according to claim 1, wherein the clamp assembly is mounted for both horizontal and vertical movement.

3. The apparatus according to claim 1, wherein the clamp assembly is mounted for horizontal movement and the saw blade assembly is horizontally disposed to cut an outermost side of the log.

4. The apparatus according to claim 3, wherein the saw blade assembly includes at least two saw blades each having a cutter positioned in a vertically-staggered orientation such that each of the saw blades cuts an outermost side of the log.

5. The apparatus according to claim 1, wherein the clamp assembly includes a pair of clamps for engaging opposing ends of the log and securing the log therebetween, at least one of the clamps being mounted for movement between an open position for receiving the log and a closed position for securing the log.

6. The apparatus according to claim 1, wherein the saw blade assembly includes at least two saw blades each having a cutter stacked in registration with each other.

7. An apparatus for producing mulch, comprising:
(a) an elongate saw blade assembly having a cutter defining a cutting plane;
(b) a clamp assembly for holding a log with its grain substantially parallel to the cutting plane; and
(c) reciprocating means for moving the clamp assembly and the saw blade assembly in a reciprocating motion relative to each other so as to feed the saw blade assembly into the outermost side of the log repetitively while the grain remains substantially parallel to the cutting plane;
(d) whereby the saw blade assembly removes thin, narrow strips of wood mulch from the log.

8. The apparatus according to claim 7, wherein the clamp assembly is mounted for both horizontal and vertical movement relative to the saw blade assembly.

9. The apparatus according to claim 7, wherein the reciprocating means includes vertical and horizontal rails to allow the clamp assembly to move in the vertical and horizontal directions.

10. The apparatus according to claim 7, wherein the clamp assembly includes a table and a pair of clamps carried by the table.

11. The apparatus according to claim 10, wherein at least one of the clamps is moveable on the table between an open position for receiving the log and a closed position for holding the log.

12. The apparatus according to claim 7, wherein the saw blade assembly includes a plurality of saw blades stacked in registration with each other, each of the saw blades comprising:
(a) a chain saw guide bar; and
(b) a cutter carried by the guide bar.

13. The apparatus according to claim 12, and further including spacers between the guide bars to prevent interference between the cutters of adjacent saw blades.

14. A method of making mulch, comprising the steps of:
(a) providing a mulch-producing apparatus having an elongate saw blade assembly having a cutter defining a cutting plane, and a clamp assembly;
(b) securing a log in the clamp assembly;
(c) moving repetitively the saw blade assembly and log relative to each other such that an outermost side of the log is moved into engagement with the saw blade assembly; and
(d) cutting along the grain of the log with the saw blade assembly to produce thin, narrow strips of wood mulch.

15. The method according to claim 14, wherein the saw blade assembly includes a plurality of saw blades each having a cutter.

16. The method according to claim 14, and further including the step of moving the clamp assembly in a horizontal direction to position the outermost side of the log above the saw blade assembly.

17. The method according to claim 16, and further including the step of moving the clamp assembly in a vertical direction to position the outermost side of the log into engagement with the saw blade assembly.

18. The method according to claim 17, and further including the steps of:
(a) moving the clamp assembly in a vertical direction to position the log above the saw blade assembly;
(b) moving the clamp assembly in a horizontal direction to position the outermost side of the log above the saw blade assembly by a thickness of the saw blade assembly; and
(c) moving the clamp assembly in a vertical direction to position the outermost side of the log into engagement with the saw blade assembly.

19. The method according to claim 14, wherein the clamp assembly includes a pair of clamps carried by a table, at least one of the clamps being moveable between an open position for receiving the log and a closed position for securing the log.
